(19) United States
(12) Patent Application Publication
(10) Pub. No.: US 2016/0001325 A1
(43) Pub. Date: Jan. 7, 2016

(54) Self-Sustaining-Vibrational and Acoustic Piezoelectric Resonator-Acoustic Refigeration Core Generator of Electricity, Heating and Cooling - SS-VAPER-ARC

(71) Applicant: Timothy James Sipp, Penasco, NM (US)

(72) Inventor: Timothy James Sipp, Penasco, NM (US)

(21) Appl. No.: 14/791,417

(22) Filed: Jul. 4, 2015

Related U.S. Application Data
(63) Continuation-in-part of application No. 13/919,841, filed on Sep. 16, 2013.
Application No. 13/919,841 is a continuation-in-part of application No. 13/919,896, filed on Sep. 16, 2013.

(51) Int. Cl. B06B 1/06; H02N 2/18

(52) U.S. Cl. CPC B06B 1/0644; H02N 2/185

(57) ABSTRACT

A Self-Sustaining-extensible-multi-stage-Vibrational-and-Acoustic-Piezoelectric-Resonator-Acoustic-Refrigeration-Core Generator of Electricity, Heating and Cooling comprises a plurality of acoustically-driven mechanically-coupled tuned-closed-column-resonator-tuned-Helmholtz-resonator-piezo-poly-passive-radiator-electromagnetic-induction-circuit vibrational-and-acoustic-piezoelectric-resonator-acoustic-refrigeration-core systems that mechanically amplifies induced sound pressure levels via standing wave resonance such that the anti-node/s of the natural resonant frequency/ies in the tuned-closed-column-resonator/s occur/s in the plane/s consistent with the coupling port/s of the attached tuned-Helmholtz resonator/s acoustically driving the tuned-Helmholtz resonator/s such that standing wave resonance occurs within the tuned-Helmholtz resonators one wall of which is a piezo-poly-passive-radiator connecting the preceding stage to the proceeding stage finally driving the axial-regenerating-stack acoustic-refrigeration-core/s of physical parameters such that standing wave resonance occurs within the acoustic-refrigeration-core such that the hot-heat-exchanger is in the center of the cavity and the cold-heat-exchanger is at the second end of the cavity protruding from the fluid-water-filled containment vessel designed to minimize vibrational translation to external environments, provide system cooling and produce steam driving mechanical-electrical turbines and for heating.

### BACKGROUND OF THE INVENTION

1. Field of the Invention

1. This invention relates to the fields of alternative energy production and acoustic energy harvesting. Specifically, this invention comprises an acoustically driven plurality of extensible mechanically-coupled tuned-closed-column-resonator-tuned-Helmholtz-resonator-passive-radiator-electromagnetic-induction-circuit vibrational and acoustic piezoelectric resonator systems that constitute a self-sustaining acoustic energy harvesting device that mechanically amplifies induced sound pressure levels via standing wave resonance such that the anti-node/s of the natural resonant frequency/ies in the tuned-closed-column-resonator/s occurs in the plane/s consistent with the coupling port/s of the attached tuned-Helmholtz resonator/s and subsystem/s acoustically driving the tuned-Helmholtz resonator/s of physical parameters such that standing wave resonance occurs within the tuned-Helmholtz resonator/s one wall of which is a passive-radiator comprising a sympathetically oscillating poled-piezo-polymer surround-mounted tympanic membrane the face/s of which is/are non-poled-piezo-polymer mounted with thin film ferromagnetic solenoids that derive electric fields from the oscillating piezo-polymer surround to self-induce magnetic fields oscillating through stationary inductor coil/s housed in the throat, that simultaneously act as regional sensors relaying operational data and charging the capacitors that power the first acoustic driver, connecting the tuned-Helmholtz resonator-passive-radiator-electromagnetic-induction-circuit to the subsequent mechanically-coupled tuned-closed-column-resonator-tuned-Helmholtz-resonator-passive-radiator-electromagnetic-induction-circuit and subsequent mechanically-coupled tuned-closed-column piezo-ceramic-resonator/s and piezo-ceramic-tuned-Helmholtz-resonator/s and subsystems generating electricity, magnetic fields, increased kinetic energy, temperatures and pressures and is self-sustaining. This Invention is extensible and scalable the power output of which is constrained by the physical limits of piezo-polymers, piezo-ceramics, electrodes, conductors, high-amplitude acoustic wave coherence, shockwave formation and choking, latent heattolerance as well as determined by the desired embodiments of the present Invention from micro-power applications utilizing ultrasonics to macro-power applications utilizing acoustics and infrasonics. The tuned-closed-column piezo-ceramic-resonators and tuned-Helmholtz piezo-ceramic-resonators are comprised of piezo-ceramics with high-efficiency electrodes configured to transmit power to an external device bonded to and contained within electrically insulated titanium shells the externalities of which are coated in titanium-nitride for high-power acoustic and infrasonic applications and of appropriate polymer materials for smaller, lower-power ultrasonic applications. The present Invention is a closed, acoustically-driven, pressurized system that intentionally increases kinetic energy and temperature via sound pressure level mechanical amplification via multiple-sequential standing wave resonances and is self-sustaining. The absence of additional active cooling mechanisms and passive heat sinks for micro-power applications dictates the maximum internal sound pressure level and corresponding heat signature determined by each such embodiment. The inclusion of acoustic-refrigeration-core-working-fluid cooling systems and passive fluid-water-filled containment vessels for larger macro-power embodiments will be addressed in this application in detail.

2. Description of the Related Art

Several academic researchers have published results from computer models and physical attempts at utilizing stand-alone open-column, both ends open, acoustic resonators, capped-open-column, one end open, resonators and various configurations of pipes and Helmholtz resonators to harvest acoustic energy from ambient sources. Their maximum results have yielded electricity of 30 milliamps (mA) at up to 1.4 volts (V) and about 0.193 milliwatts (mW). Most of these attempts at acoustic energy harvesting (AEH) utilize some combination of piezo-polymers, PVDF, and/or piezo-ceramics, PZT 5A/H, placed either in open-air, linearly along the long axis of the resonating column or affixed as the back wall of the Helmholtz resonator. All of these systems attempt to capture ambient acoustics and translate specific frequencies into electricity. These experiments will not likely yield results significant enough to be useful in commercial applications for anything larger than a small sensor i.e. a self-powered microphone, transducer, opto-electric device or near-field radio-frequency transceiver. The major hurdle for all of these unsuccessful attempts at AEH is largely due to the fact that the academics and engineers undertaking these experiments are not highly-trained in empirical non-linear high-amplitude acoustics and cavity resonance or cross-trained in materials science and aero-acoustics and therefore they approach the problem from the wrong perspective with the wrong set of tools.

Acoustic research at the Los Alamos National Lab has pioneered exciting work in thermo-acoustics and acoustic refrigeration using thermo-acoustic-Sterling-heat-engine-orifice-pulse-tube-refrigeration and axial-regenerating stack acoustic refrigeration for high-frequency low amplitude and low frequency, high amplitude acoustic-refrigeration for natural gas liquefaction. No one has used a plurality of sequential extensible tuned-closed-column-resonator-tuned-Helmholtz-resonator-passive-radiator-assemblies to mechanically amplify the input acoustic wave via a self-sustaining piezo-poly-passive-radiator-electromagnetic-induction-circuit powering the first acoustic driver eliminating the need for fuel while generating electricity, heating and cooling.

### BRIEF SUMMARY OF THE PRESENT INVENTION

This invention relates to the fields of alternative energy production and acoustic energy harvesting (AEH). Specifically, this invention comprises an acoustically-driven plurality of extensible mechanically-coupled tuned-closed-column-resonator-tuned-Helmholtz-resonator-passive-radiator vibrational and acoustic piezoelectric resonator systems that constitute an acoustic energy harvesting (AEH) device that mechanically amplifies induced sound pressure levels via standing wave resonance such that the anti-node/s of the natural resonant frequency/ies in the tuned-closed-column-resonator/s occurs in the plane/s consistent with the coupling port/s of the attached tuned-Helmholtz resonator/s and subsystem/s acoustically driving the tuned-Helmholtz resonator/s of physical parameters such that standing wave resonance occurs within the tuned-Helmholtz resonator/s, one wall of which is a passive-radiator comprising a sympathetically oscillating poled-piezo-polymer surround-mounted tympanic membrane the face/s of which is/are non-poled-piezo-polymer mounted with thin film ferromagnetic solenoids that derive electric fields from the oscillating piezo-polymer surround to self-induce magnetic fields oscillating through stationary inductor coil/s housed in the throat, simultaneously acting as regional sensors relaying operational data and charging the capacitors that power the first acoustic driver, connecting the tuned-Helmholtz resonator-passive-radiator to the subsequent mechanically-coupled tuned-closed-column-resonator-tuned-Helmholtz-resonator-passive-radiator and subsequent mechanically-coupled tuned-closed-column piezo-ceramic-resonator/s and tuned-piezo-ceramic-Helmholtz-resonator/s with electrodes, configured to transmit power to an external device, and axial-regenerating-stack acoustic-refrigeration-cores such that the hot-heat-exchanger is in the center of the cavity and the cold-heat-exchanger is at the second end of the cavity protruding from the fluid-water-filled containment vessel designed to minimize vibrational translation to external environments, provide system cooling and produce steam driving mechanical-electrical turbines and for heating. This system generates electricity, magnetic fields, pressurized steam and cooling, and is self-sustaining. This Invention is self-sustaining, extensible and scalable, the power output of which is constrained by the physical limits of piezo-polymers, piezo-ceramics, electrodes, conductors, high-amplitude acoustic wave coherence, shockwave formation and choking, latent heat tolerance as well as determined by the desired embodiments of the present Invention from micro-power applications utilizing ultrasonics to macro-power applications utilizing acoustics and infrasonics. The tuned-closed-column piezo-ceramic-resonators and tuned-Helmholtz piezo-ceramic-resonators are comprised of piezo-ceramics with high-efficiency electrodes, configured to transmit power to an external device, bonded to and contained within electrically insulated titanium shells the externalities of which are coated in titanium-nitride for high-power acoustic and infrasonic applications and of appropriate polymer materials for smaller, lower-power ultrasonic applications. The present Invention is a self-sustaining, closed, acoustically-driven, pressurized system that intentionally increases kinetic energy and temperature via sound pressure mechanical amplification via standing wave resonance. The absence of additional active cooling mechanisms and passive heat sinks for micro-power applications dictates the maximum internal sound pressure level and corresponding heat signature determined by each such embodiment. The inclusion of acoustic-refrigeration-core-working-fluid active-cooling systems and passive fluid-water-filled containment vessel designed to minimize vibrational translation to external environments, provide system cooling and produce steam driving mechanical-electrical turbines and for heating for larger macro-power embodiments will be addressed in this application in detail.

In a tuned-closed-column resonating cavity both ends are closed. The first acoustic driver is at the first end and the second end comprises a plunger with both manual and automatic controls for changing the volume and therefore the resonant frequency of the closed-column resonating cavity thereby rendering the closed-column resonating cavity tunable. The sound pressure level (SPL) of the input acoustic signal is increased by 32 dB by standing wave resonance which is 512 times higher than the input pressure. The perpendicularly mounted tuned-Helmholtz resonator/s is/are located at the anti-node/s of the incident standing wave in the previous tuned-closed-column resonating cavity and are mechanically-coupled with the preceding closed-column resonating cavity by their shared body of gas. The tuned-Helmholtz-resonators have one wall comprising a plunger with both manual and automatic controls for changing the volume of the tuned-Helmholtz-resonator rendering the Helmholtz-resonator tunable. The SPL inside the tuned-Helmholtz resonators increases by an additional 32 dB because of the input frequency stimulating the tuned-Helmholtz resonating cavities natural resonant frequency. Accordingly, the original acoustic input signal of 32 dB, barely a whisper, becomes 64 dB, casual conversation level, due to standing wave resonance in the first tuned-closed-column resonating cavity and increases an additional 32 dB to 96 dB, using a belt-sander, in the first tuned-Helmholtz resonator, an increase of 1024 times the input pressure wave via mechanical amplification due to multiple sequential cavity resonances. The acoustic-refrigeration-cores are axial-regenerating-stack acoustic-refrigeration-cores such that the hot-heat-exchanger is in the center of the cavity and the cold-heat-exchanger is at the second end of the cavity protruding from the fluid-water-filled containment vessel designed to minimize vibrational translation to external environments, provide system cooling and produce steam driving mechanical-electrical turbines and for heating. This system generates electricity, magnetic fields, steam and cooling, and is self-sustaining. This Invention transcends the obvious tuned-closed-column-tuned-Helmholtz-resonator construction by making one wall of the tuned-Helmholtz-resonator a passive-radiator by fabricating one wall out of a sympathetically oscillating poled-piezo-polymer surround-mounted tympanic membrane the face/s of which is/are non-poled-piezo-polymer mounted with thin film ferromagnetic solenoids that derive electric fields from the oscillating piezo-polymer surround to self-induce magnetic fields that oscillate along the passive-radiator's length of travel, in response to the incident SPL commensurate with the frequency and amplitude within the tuned-Helmholtz-resonator, through stationary inductor coil/s housed in the throat connecting the tuned-Helmholtz resonator-passive-radiator-electromagnetic-induction-circuit, acting as regional sensors providing real-time systems operations data and recharging the internal capacitors that power the first acoustic driver, to the two subsequent mechanically-coupled tuned-closed-column-resonator/s-tuned-Helmholtz-resonator/s-passive-radiator/s-electromagnetic-inductions-circuit/s stages until driving the tuned-piezo-ceramic-closed-column-resonator/s and tuned-piezo-ceramic-Helmholtz-resonator/s connected to electrodes configured to transmit power to an external device. Each of these tuned-closed-column-resonator-tuned-Helmholtz-resonator-passive-radiator-electromagnetic-induction-circuit assemblies accepts the previously mechanically amplified acoustic standing wave and mechanically amplifies it an additional 64 dB, minus losses due to the spring constant, k, of the poled-piezo-poly-surround, acoustic impedance of the gas and cavities and friction, before acoustically driving the subsequent resonator stage via the passive radiator wall of the Helmholtz resonator. The poled-piezo-poly surround-mounted non-poled-piezo-poly-tympanic-membrane-passive-radiator-electromagnetic-induction-circuit generates electric fields that pass through electrodes into a conducting wire into thin-film ferromagnetic solenoids generating magnetic fields that induce exponentially higher electric fields in the throat-mounted induction coils as the tympanic membrane that the ferromagnetic solenoids are attached to oscillates sympathetically through the length of its lateral travel in response to the incident SPL commensurate with the frequency and amplitude within the Helmholtz-resonator. These electromagnetic-induction signals simultaneously act as regional sensors relaying operational data and charging the capacitors that power the first acoustic driver making this invention self-sustaining. The present invention repeats this mechanical amplification via acoustically driving mechanically-coupled tuned-closed-column-resonator/s-tuned-Helmholtz-resonator/s-passive-radiator-electromagnetic-induction assembly/ies stages according to the desired power specifications of each embodiment up to the physical limits of the materials. This present invention can mechanically amplify a 32 dB input signal into 190+dB with three sequential stages of mechanically-coupled tuned-closed-column resonator/s-tuned-Helmholtz-resonator/s-passive-radiator/s-electromagnetic-induction-circuit assemblies, effectively turning a whisper into a shockwave. These 190+dB shockwave intense acoustic waves generate SPLs that translate to 10+ megawatts (MW) per square meter of acoustic power. The piezo-ceramic lined tuned-closed-column and tuned-Helmholtz resonators at the termination of the 3^{rd} stages translate up to 700+ watts of electricity per square centimeter of piezo-ceramic exposed to the pressures and temperatures at 190 dB and up to 7 kW per square centimeter at 200 dB. Methods for stimulating the Young's modulus of the piezo-ceramics include combining the sonic frequency/ies with the infrared signature from the gas type and stimulating the plasma in the final stage tuned-closed-column-piezo-ceramic-resonator/s and tuned-piezo-ceramic-Helmholtz-resonator/s with an electric field to stimulate spontaneous photon emission of a known spectrum that in concert with the other methods can stimulate electrical output up to the physical limits of the bulk modulus of the piezo materials connected to high-efficiency electrodes configured to transmit power to an external device. The pressures and temperatures in this last stage of acoustic and infrasonic embodiments are dangerously high and drive axial-regenerating-stack acoustic-refrigeration-cores such that the hot-heat-exchanger is in the center of the cavity and the cold-heat-exchangers are at the first end and the second end of the cavity, the second end protruding from the liquid-water-filled containment vessel, supplying active cooling to prevent material fatigue and catastrophic systems failure and noise reduction and cancelling to prevent facilities damage and death or bodily harm to people and animals. This system generates electricity, magnetic fields, steam and cooling, and is self-sustaining. The ultrasonic embodiments of the present Invention also require a combination of active and passive cooling systems at these higher power output levels, but do not require sound cancellation as the target frequencies are above human and domestic animal hearing capacities, however, prolonged near-field and contact exposure can cause serious tissue damage over time.

The ultrasonic embodiments of the present Invention are envisaged as battery replacement technology for most existing battery types from AAA 1.5V in remote controls, to Li-Ion batteries in handheld and wearable electronics and portable computing devices like laptops and tablets, and can be scaled up to replace electric vehicle, marine, and aeronautical battery systems and facilities-based back-up power supplies. The acoustic and infrasonic embodiments of the present Invention are envisaged as an alternative to fossil-fuel, hydro, geo-thermal, solar, wind and nuclear based electric power production systems for industrial and commercial grid delivery as well as stand-alone off-grid large facilities power supply in addition to vehicle, vessel and craft power. The present invention could also efficiently power cryogenic cooling for high-energy physics labs, gas liquefaction of industry as well as supply commercial heating and cooling for industrial, commercial and retail spaces. The use of the VAPER-ARC™ reactors for energy production, electric jet flight and marine shipping would eliminate the three largest causes of GHGs and soot contributing to negative planetary evolution a.k.a. climate change. These particular embodiments of the present Invention would also lower the overall operating costs of any business utilizing them from fuel-savings, carbon-credits, regulatory costs and infrastructure costs.

Real world applications for the present invention include but are not limited to configurations in high-energy physics research facilities, cryogenics research facilities, public spaces such as, but not limited to, power generating stations, factories, stadiums, train stations & rail yards, subway stations, bus stations, airports, shipyards, ports, tunnels, bridges, highways, roadways, gymnasiums, concert halls, office buildings, hospitals, healthcare organizations, detention facilities, correctional facilities, military facilities, commercial spaces, retail spaces, and industrial & manufacturing spaces. Further applications could include, but not be limited to, wearable and handheld electronics and electrical equipment, vehicles and transportation of any configuration including but not limited to space-stations, spacecraft, sub-orbital craft, satellites, airplanes, helicopters, fixed-wing and rotary-wing aircraft, ultralight aircraft, UAVs, MUAVs, UUAVs, parachutes, flying suits, flying armored suits, prosthetics, wearable computing platforms, armored terrestrial suits, HAZMAT suits, diving suits/systems, spacesuits, EVA spacesuits, locomotives, trains, automobiles, trucks, construction vehicles, earthmovers, mining equipment, half-tracks, tracked vehicles, watercraft, hovercraft, submarines, drill-rigs, floating drill-rigs, motorcycles, unicycles, motor-scooters, electric bicycles, ATVs, golf carts, and snowmobiles. The preceding examples constitute some, not all, possible configurations and applications of the present invention. Variations should not materially alter the nature of the present invention. Thus the scope of the invention should be fixed by the following claims rather than any specific example cited.

### BRIEF DESCRIPTION OF THE DRAWINGS

FIG. 1 is a side view illustration of an extensible three-stage mechanically-coupled tuned-closed-column-resonator-Helmholtz-resonator-passive-radiator-electromagnetic-induction assembly comprising the first acoustic driver (12) and control system (101, 10, 11) in an enclosure (1), the first tuned-closed-column-resonator (2), manual (21) and servo (22) operated tuning plunger (20), the first tuned-Helmholtz-resonator (3), manual (31) and servo (32) operated tuning plunger (30), the first passive-radiator-electromagnetic-induction assembly (4), the second closed-column-resonator (5), manual (51) and servo (52) operated tuning plunger (50), the second tuned-Helmholtz-resonator (3), manual (31) and servo (32) operated tuning plunger (30), the second passive-radiator-electromagnetic-induction assembly (4), the third closed-column-piezo-ceramic-resonator (6), manual (61) and servo (62) operated tuning plunger (60), the closed-column piezo-ceramic-array (63) and the final piezo-ceramic-Helmholtz-resonator (7) with high-efficiency electrodes (74, 75) connected to a master electrode (795) configured to transmit power (797) to an external device.

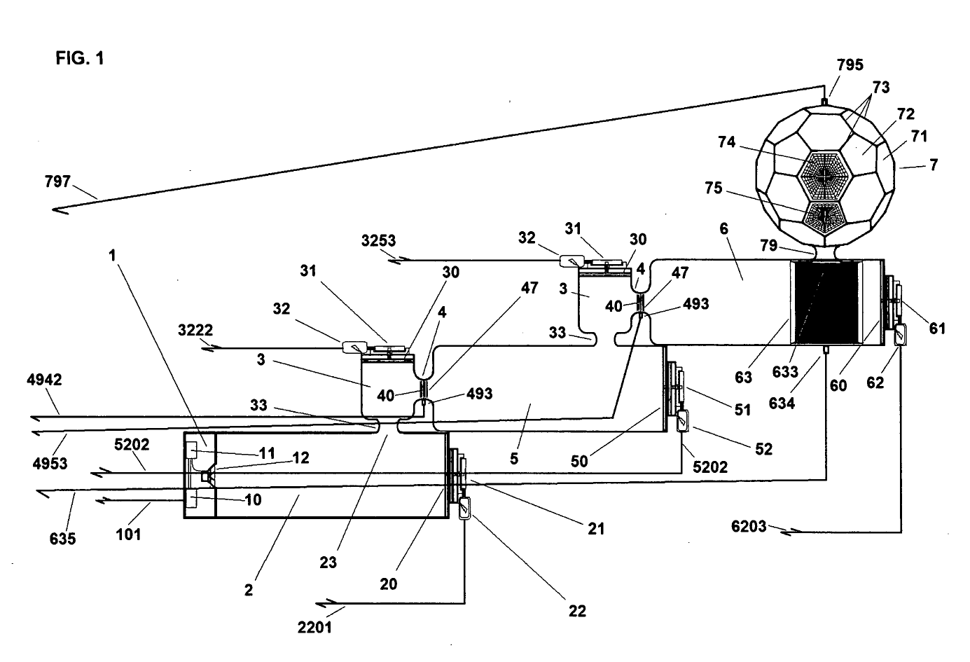

FIG. 2 is a two-perspective view, front and right-side, of the passive-radiator (40) comprising a rigid flange (41) with eight tapped holes (411) for affixing to the throat (49—not pictured) between the Helmholtz-resonator and subsequent closed-column-resonator (not pictured), further comprising a poled piezo-poly surround (42), a non-poled piezo-poly tympanic membrane (43), thin-film ferromagnetic solenoids (44) connected in series by a thin conductor (45) terminating in electrodes (46).

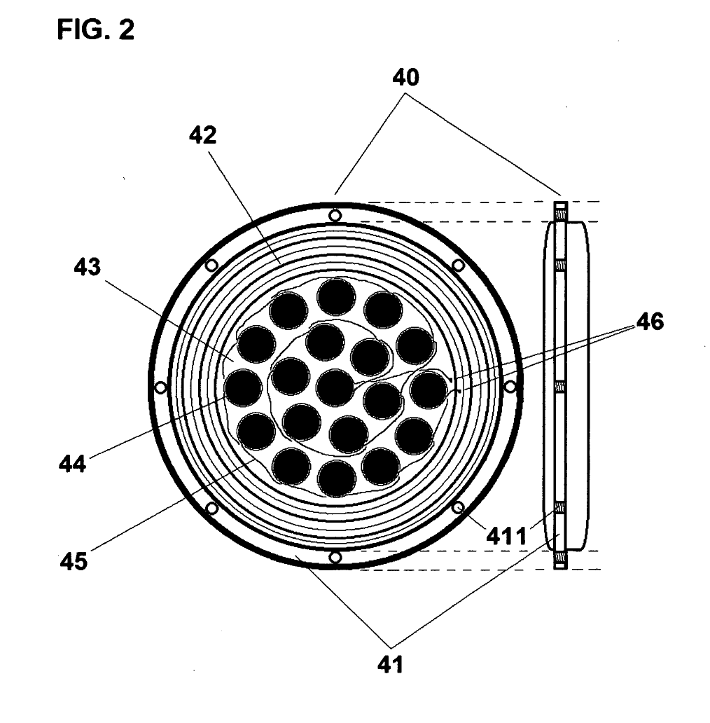

FIG. 3 is a two-perspective view, right-side and front, of the electromagnetic-induction coils (47) and electrodes (48) embedded in the electrically-insulated throat (not pictured) connecting the previous Helmholtz-resonator (not pictured) to the subsequent closed-column-resonator (not pictured) in the piezo-poly-passive-radiator-electromagnetic-induction assembly area (not pictured). The signal induced into these coils is sufficient to act as feedback operations data and to charge the capacitors that power the first acoustic driver making this Invention self-sustaining.

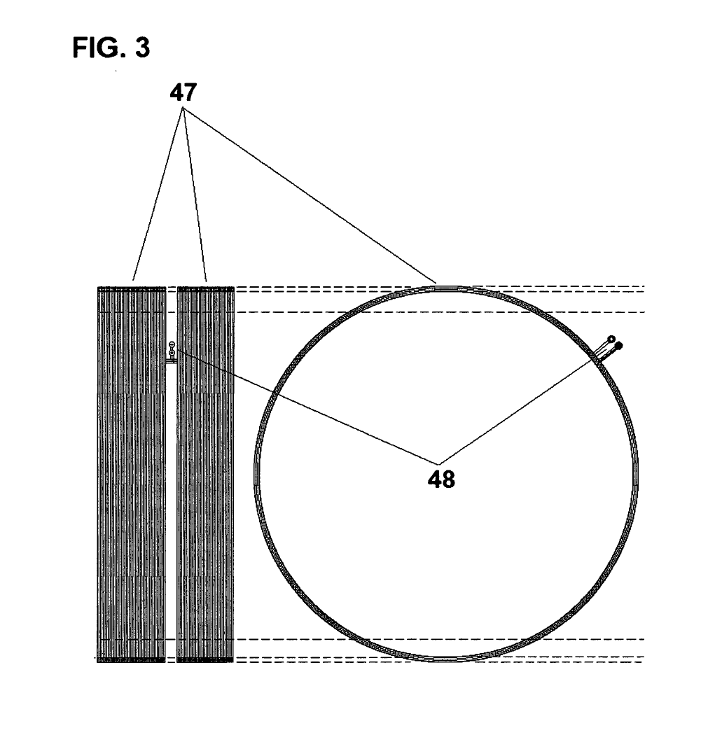

FIG. 4 is a two-perspective view, front and right-side, of the passive-radiator-electromagnetic-induction-throat (49) of the piezo-poly-passive-radiator-electromagnetic-induction assembly (not pictured) further comprising a flange (490) for connecting to the previous Helmholtz-resonator (not pictured) and subsequent closed-column-resonator (not pictured) an electrically-insulated cavity for the electromagnetic-induction-coils (491) and electrodes (493) and an internal flange (492) for mounting the piezo-poly-passive-radiator-electromagnetic-induction assembly (not pictured).

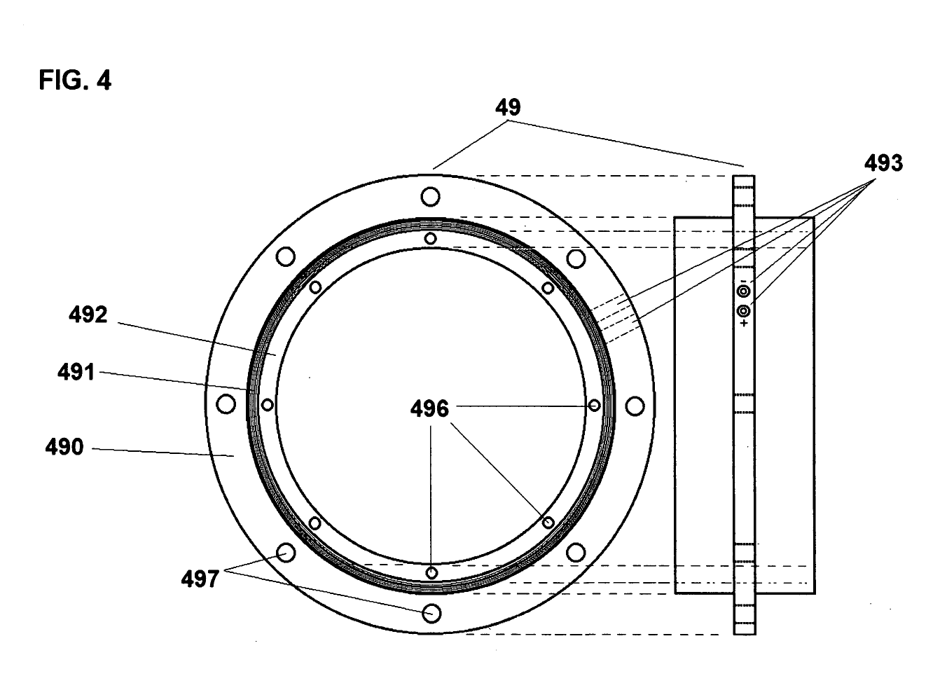

FIG. 5 is an exploded two-perspective view, front and right-side, of the piezo-poly-passive-radiator-electromagnetic-induction-throat assembly (4) comprising a piezo-poly-passive-radiator (40), electromagnetic-induction-coils (47), electromagnetic-induction electrodes (48) and passive-radiator-electromagnetic-induction throat (49).

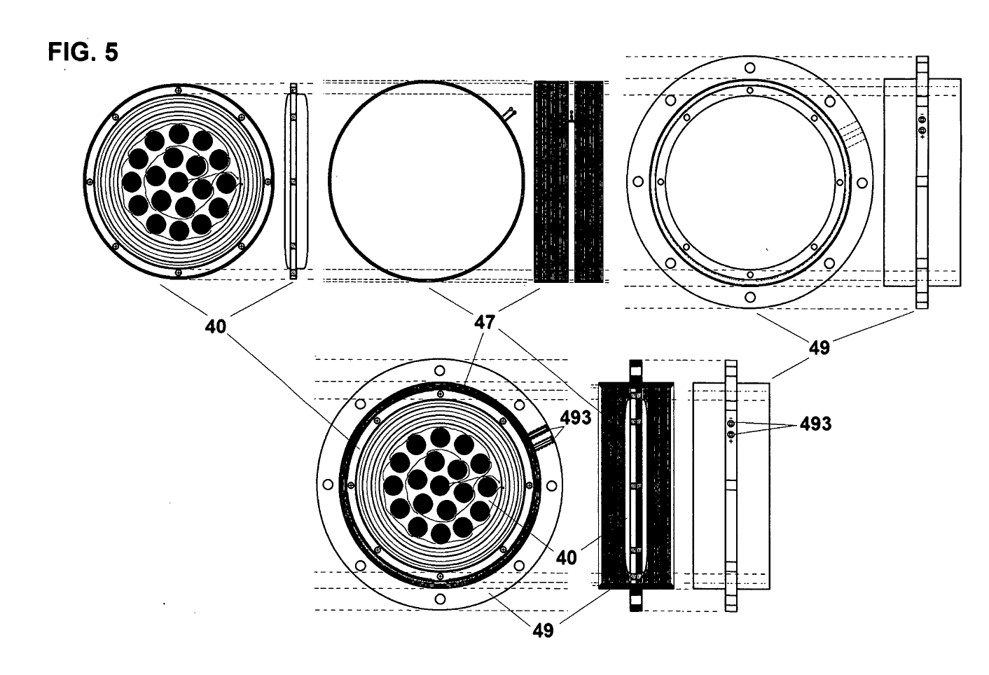

FIG. 6 is an illustration of multiple two-perspective views, front and right-side, of the closed-column-piezo-ceramic-arrays (63, 64, 65) that can be installed in the final-stage closed-column-resonator (6) to harvest electricity in addition to the final-stage piezo-ceramic-Helmholtz-resonator (7, 70, 701) with electrodes (74, 75, 731, 732, 795) configured to transmit power (797) to an external device. There are three variations of closed-column-piezo-ceramic-arrays, the first (63) having one port (633) electrodes (634) configured to transmit power (635) to an external device, the second (64) having two ports (643) electrodes (644) configured to transmit power (645) to an external device and the third (65) having no ports and electrodes (654) configured to transmit power (655) to an external device.

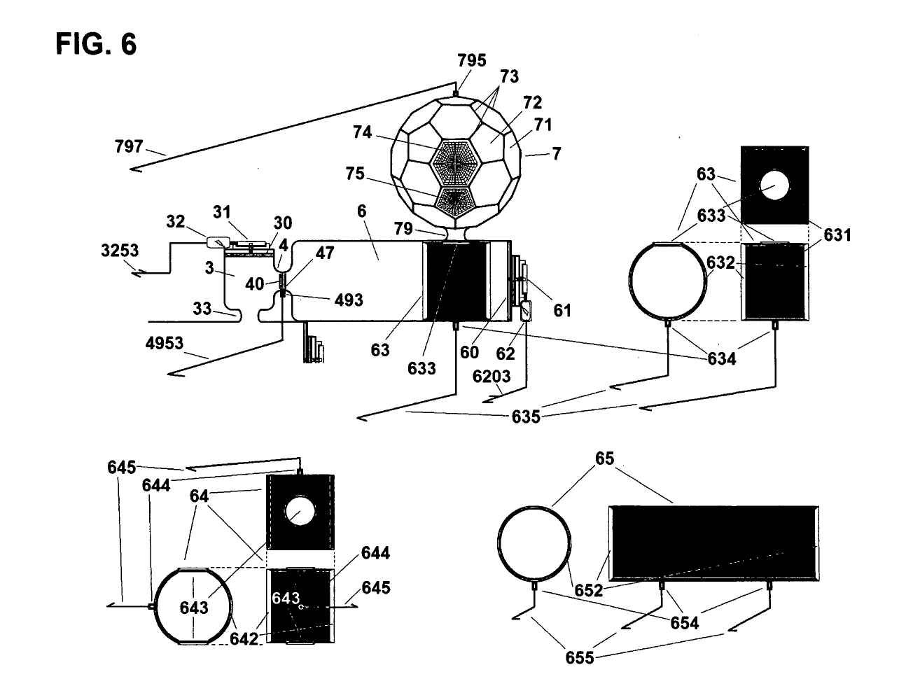

FIG. 7 is an illustration of a two-perspective view, front and bottom, of a piezo-ceramic-tuned-Helmholtz-resonator (7) in this instance in the form of a truncated icosahedron comprising hexagonal piezo-ceramic sections (71) with hexagonal spider-web electrodes (74) pentagonal piezo-ceramic sections (72) with pentagonal electrodes (75) encased in a rigid insulated geometry (73) with embedded positive electrodes (731) and embedded negative electrodes (732), master electrode (795) configured to transmit power (797) to an external device, the Helmholtz-radiator neck (79) with outer diameter (791) tapered throat (792) and port (793).

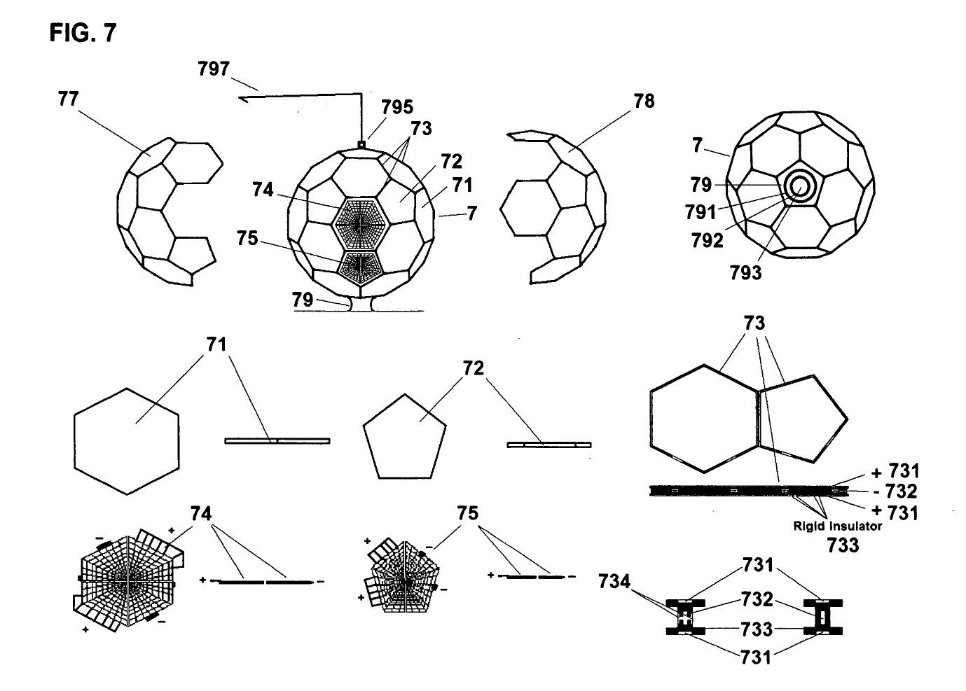

FIG. 8 is a side and end view of two axial-regenerating-stack (7772) acoustic-refrigeration-cores (777, 7771) attached to the previous tuned-closed-column-resonator such that the hot-heat-exchanger (7773) is in the center of the cavity and the cold-heat-exchangers (7774) are at the first end and the second end of the cavity, the second end consisting of a thick endcap (7775) acting as a cold thermal mass for cold-heat-exchange with an external working-fluid-cooling system, the first end cold-heat exchanger regulating internal temperature.

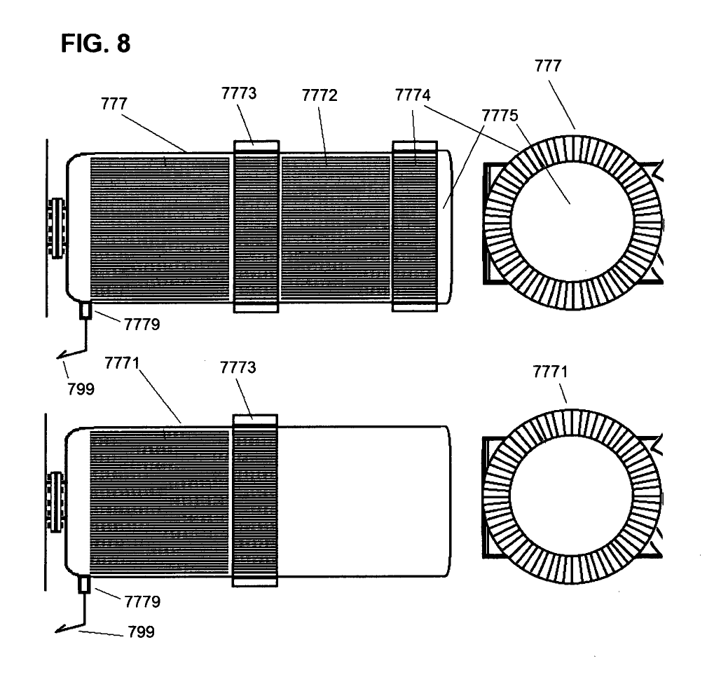

FIG. 9 is a four-perspective illustration of an ultrasonic embodiment envisaged as a battery replacement technology substituting the final stage piezo-ceramic-tuned-Helmholtz-resonator with an additional piezo-ceramic-tuned-closed-column-resonator.

FIG. 10 is a top-down view of a possible two-dimensional acoustic and infrasonic embodiment of the present invention without piezo-ceramic-tuned-Helmholtz-resonators.

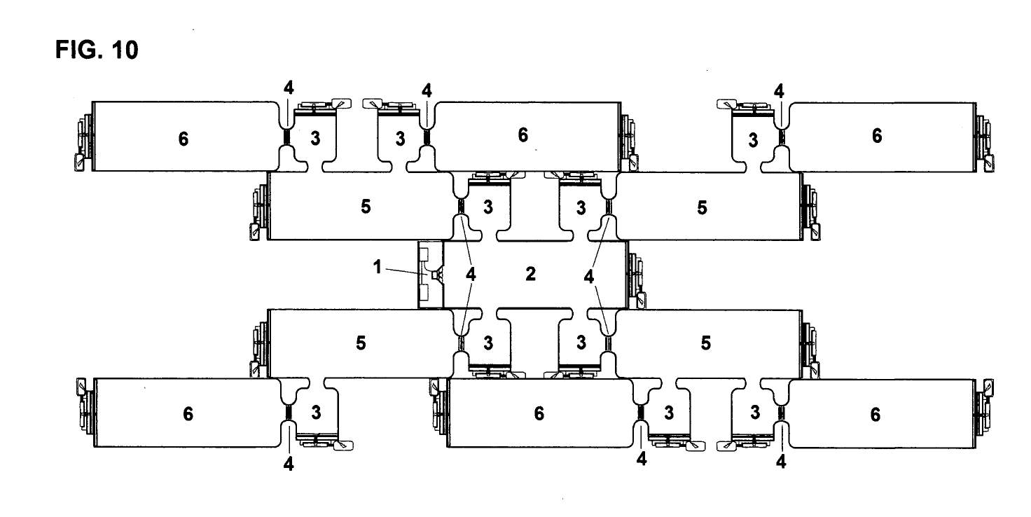

FIG. 11 is a top-down view of a possible three-dimensional acoustic and infrasonic embodiment of the present invention without piezo-ceramic-tuned-Helmholtz-resonators.

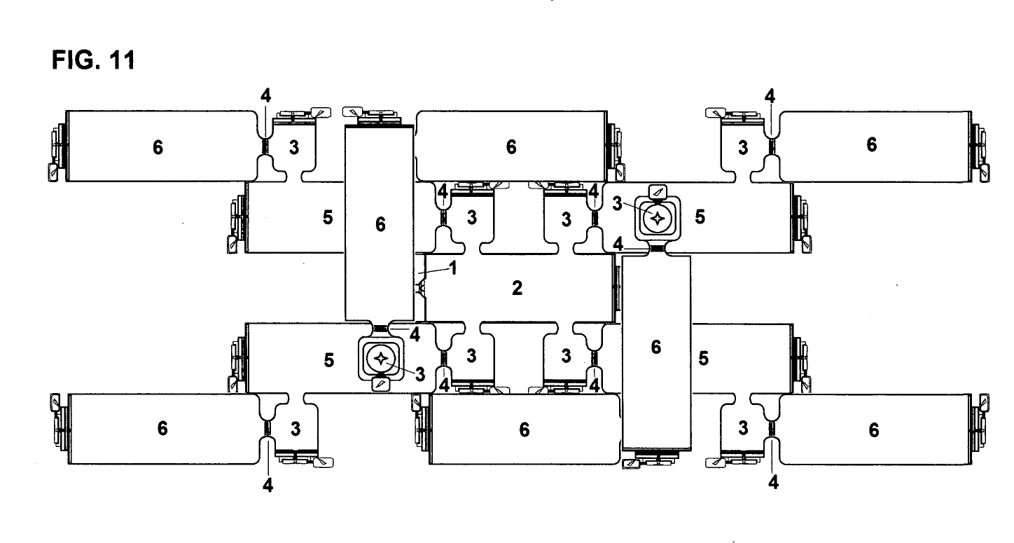

FIG. 12 is a top-down view of a possible three-dimensional acoustic and infrasonic embodiment of the present invention with three different sizes of piezo-ceramic-tuned-Helmholtz-resonators (7, 70, 701) configured for optimal electricity generation and four acoustic-refrigeration-cores (777) as an example of potential active-cooling and pressure-driven subsystems.

FIG. 13 is a top-down view of a possible three-dimensional acoustic and infrasonic embodiment of the present invention detailing the electrical transmission (797, 798, 799), sensors and self-sustaining internal-capacitor charging (42, 43, 44, 45, 46, 47, 48, 4941, 4942, 4943, 4944, 4951, 4952, 4953, 4954, 4955, 4956, 4957, 4958) and control systems (101, 20, 21, 22, 2201, 50, 51, 52, 5201, 5202, 5203, 5204 60, 61, 62, 6201, 6202, 6203, 6204, 6205, 6206, 6207, 6208).

FIG. 14 is the end-view of a possible three-dimensional acoustic and infrasonic embodiment of the present invention.

FIG. 15 is the side-view of a possible three-dimensional acoustic and infrasonic embodiment of the present invention.

FIG. 16 is a top-down view of the base (8) of the two and three-dimensional acoustic and infrasonic embodiments of the present invention to support the vibrational and acoustic piezo resonator system while minimizing vibrational translation to exogenous elements.

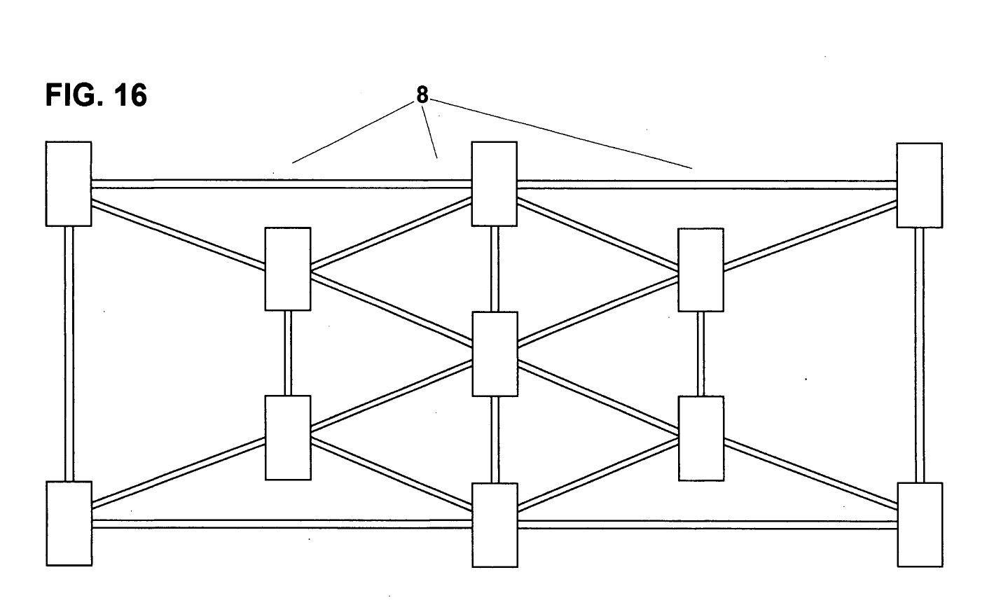

FIG. 17 is a side-view of the base (8) of the two and three-dimensional acoustic and infrasonic embodiments of the present invention to support the vibrational and acoustic piezo resonator system while minimizing vibrational translation to exogenous elements.

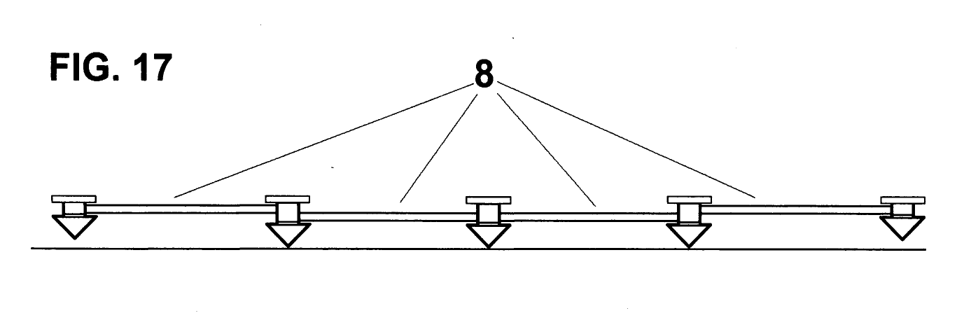

FIG. 18 is the bottom-up-view of the base (8) of the two and three-dimensional acoustic and infrasonic embodiments of the present invention to support the vibrational and acoustic piezo resonator system while minimizing vibrational translation to exogenous elements.

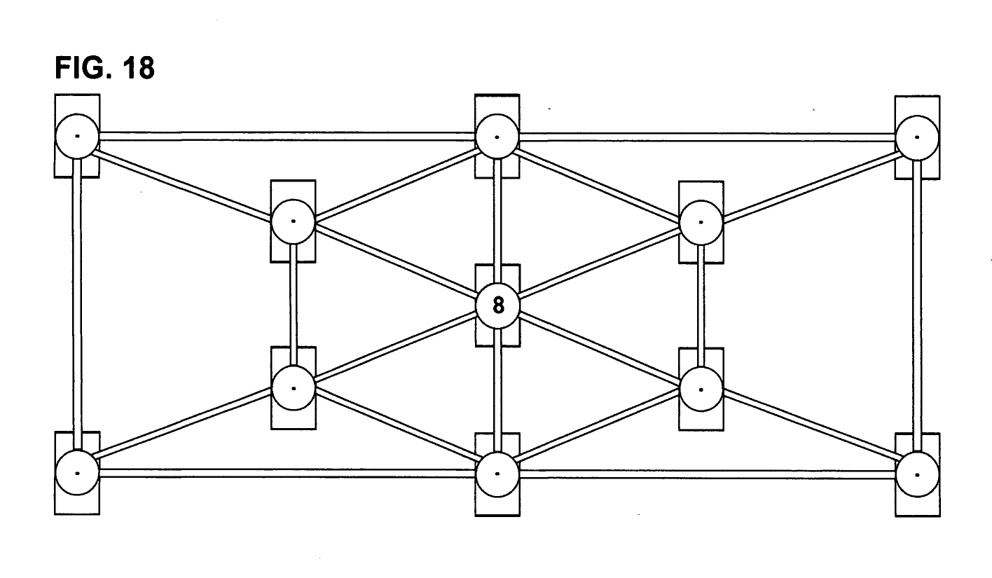

FIG. 19 is the end-view of a possible three-dimensional embodiment of the present invention enclosed in a pressurized containment vessel (9) with lower-hemisphere (91) upper-hemisphere (92) vibration-minimizing legs (93) liquid-water drain-plugs (94) acoustic-refrigeration ports (90) lock-down screw-tapped holes (99) and steam evacuation port (95).

FIG. 20 is a side-view of a possible three-dimensional embodiment of the present invention enclosed in a pressurized containment vessel (9) with lower-hemisphere (91) upper-hemisphere (92) vibration-minimizing legs (93) liquid-water drain-plugs (94) steam evacuation port (95) cold-water-return port (96) electrical control and sensor systems port (97) electrical transport system port (98) and lock-down screw-tapped holes (99).

FIG. 21 is an end-view of the externality of the present invention enclosed in a pressurized containment vessel (9) with lower-hemisphere (91) upper-hemisphere (92) vibration-minimizing legs (93) liquid-water drain-plugs (94) steam evacuation port (95) cold-water-return port (96) and electrical control and sensor systems port (97).

FIG. 22 is an end-view of the externality of the present invention enclosed in a pressurized containment vessel (9) with lower-hemisphere (91) upper-hemisphere (92) vibration-minimizing legs (93) liquid-water drain-plugs (94) steam evacuation port (95) and electrical transport system port (98).

FIG. 23 is a side-view of the externality of the present invention enclosed in a pressurized containment vessel (9) with lower-hemisphere (91) upper-hemisphere (92) vibration-minimizing legs (93) liquid-water drain-plugs (94) steam evacuation port (95) cold-water-return port (96) electrical control and sensor systems port (97) electrical transport system port (98) and protruding acoustic refrigeration core cold-heat exchangers (777).

### DETAILED DESCRIPTION OF THE PRESENT INVENTION

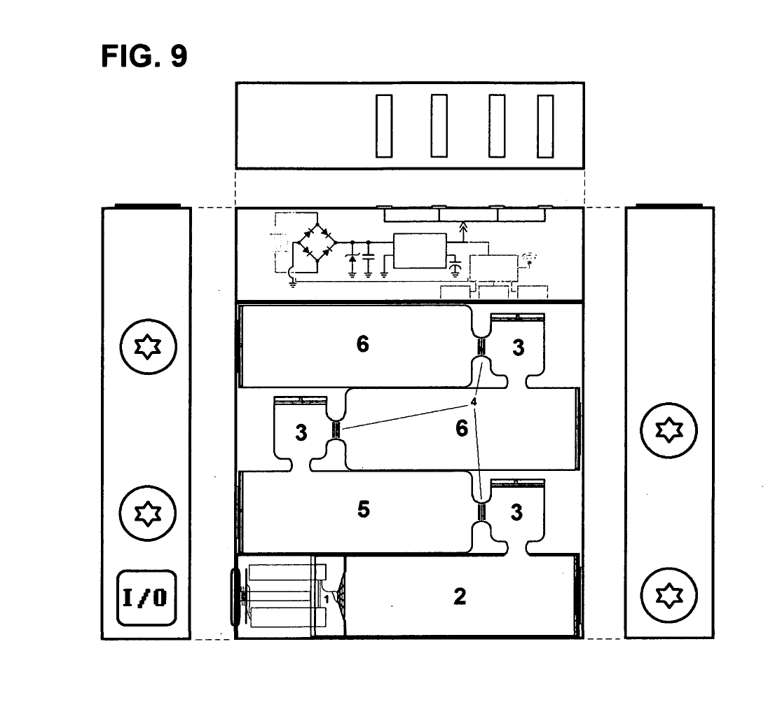

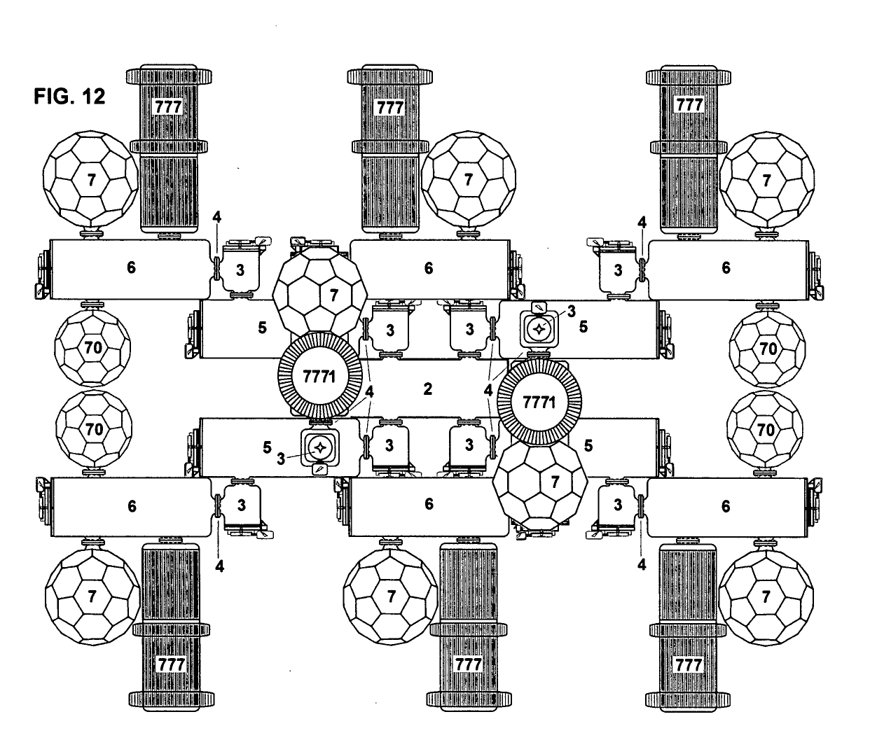

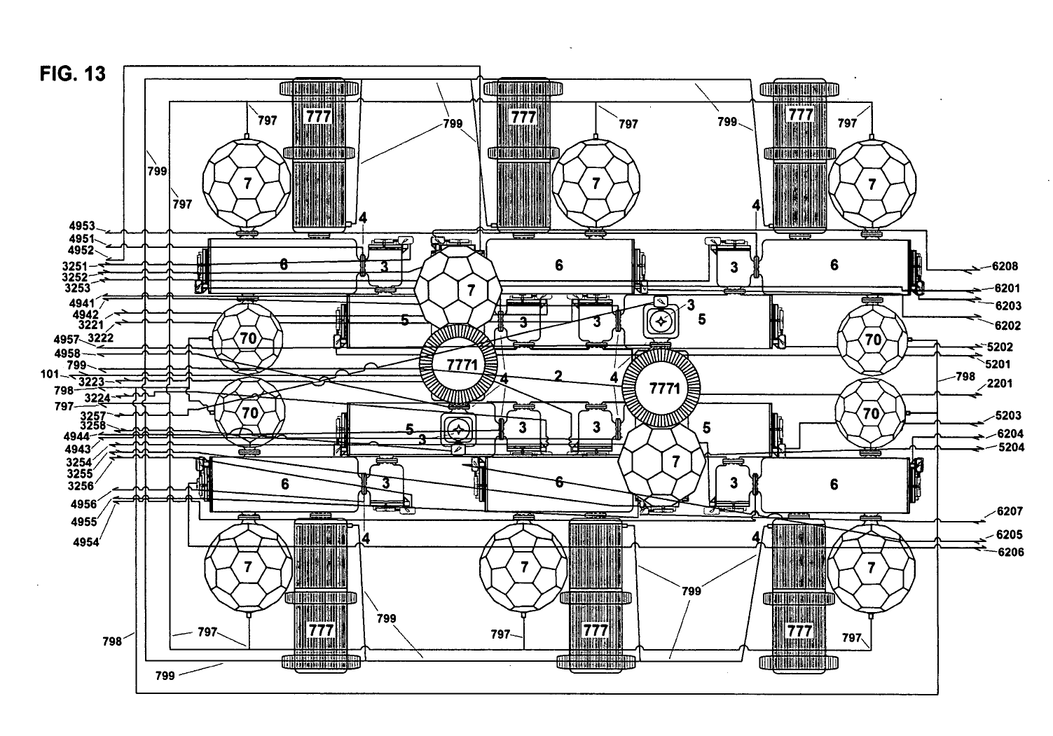

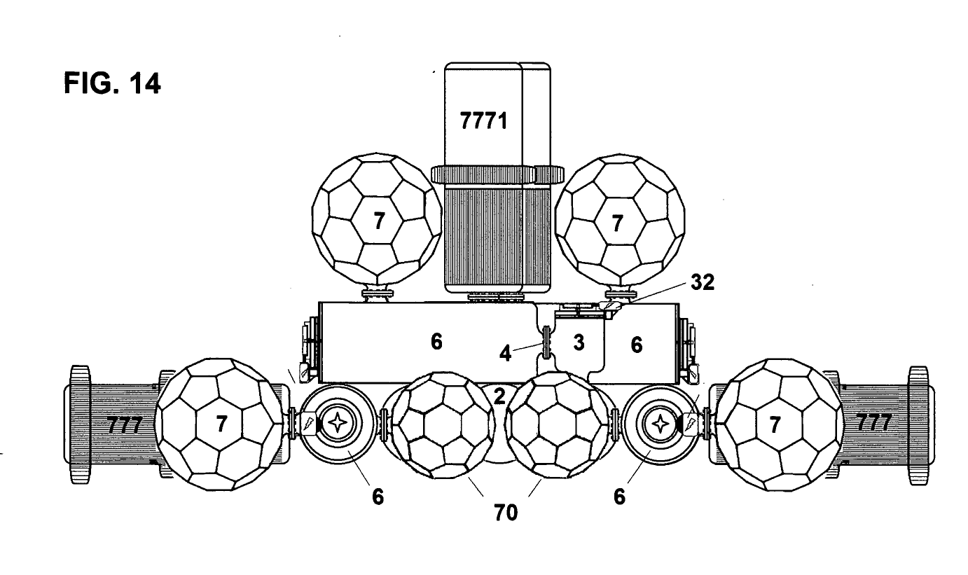

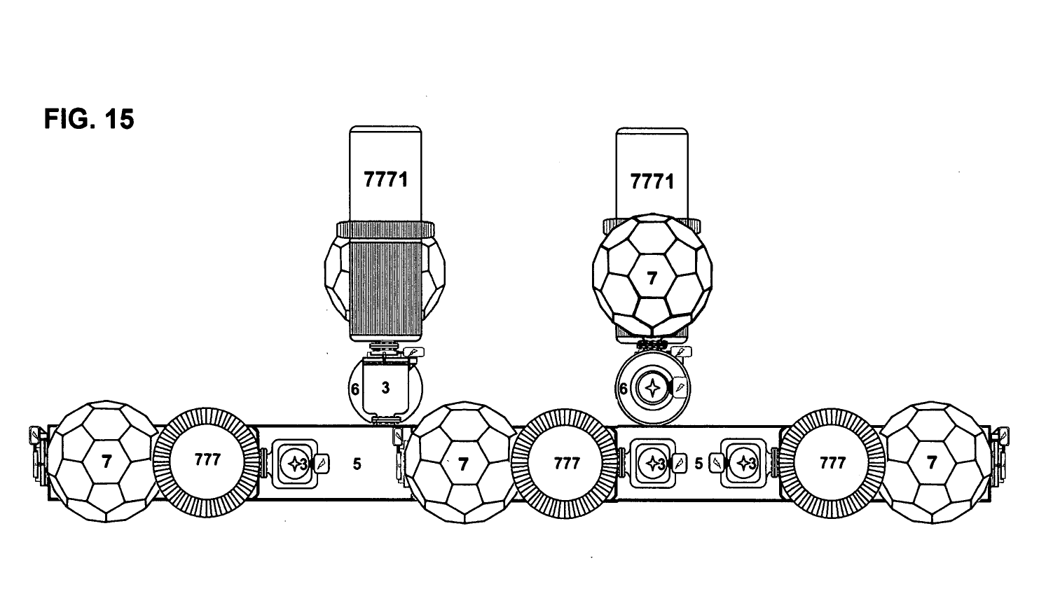

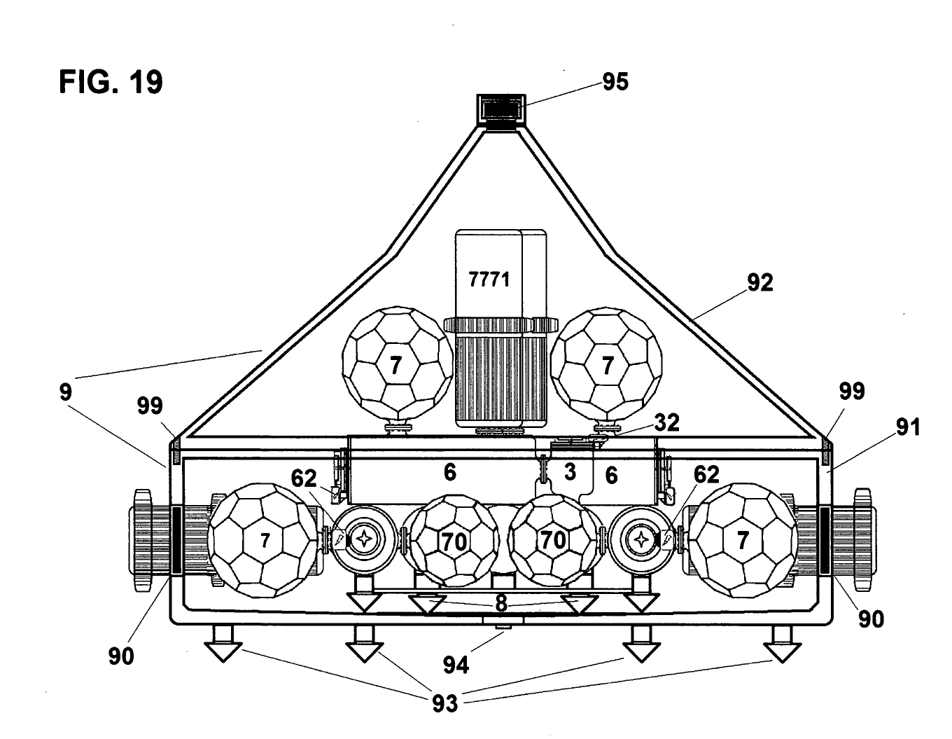

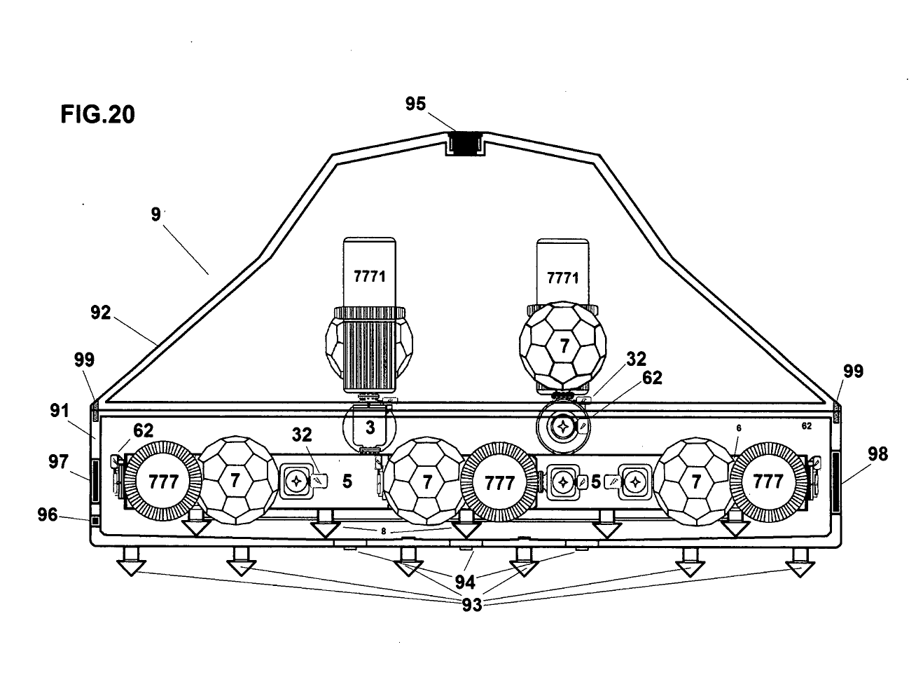

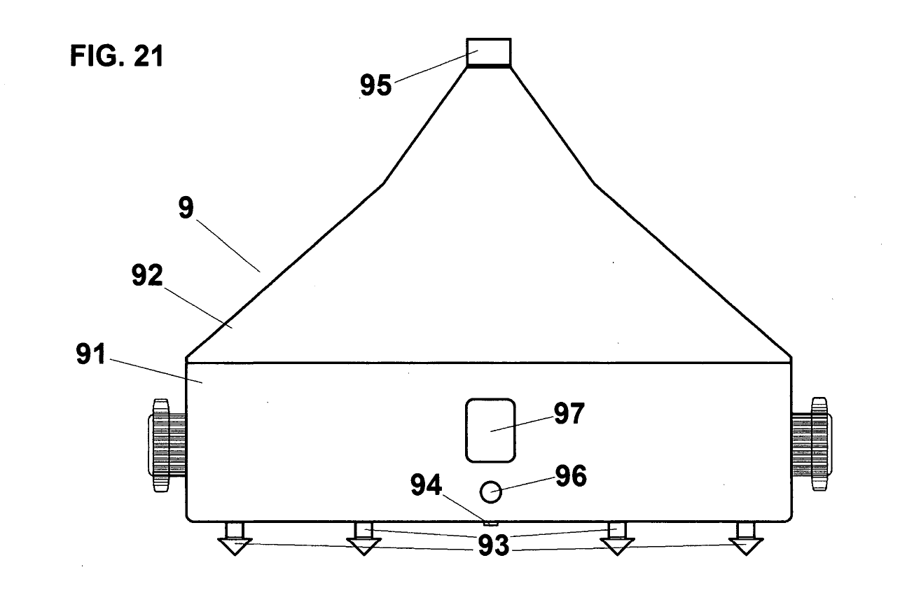

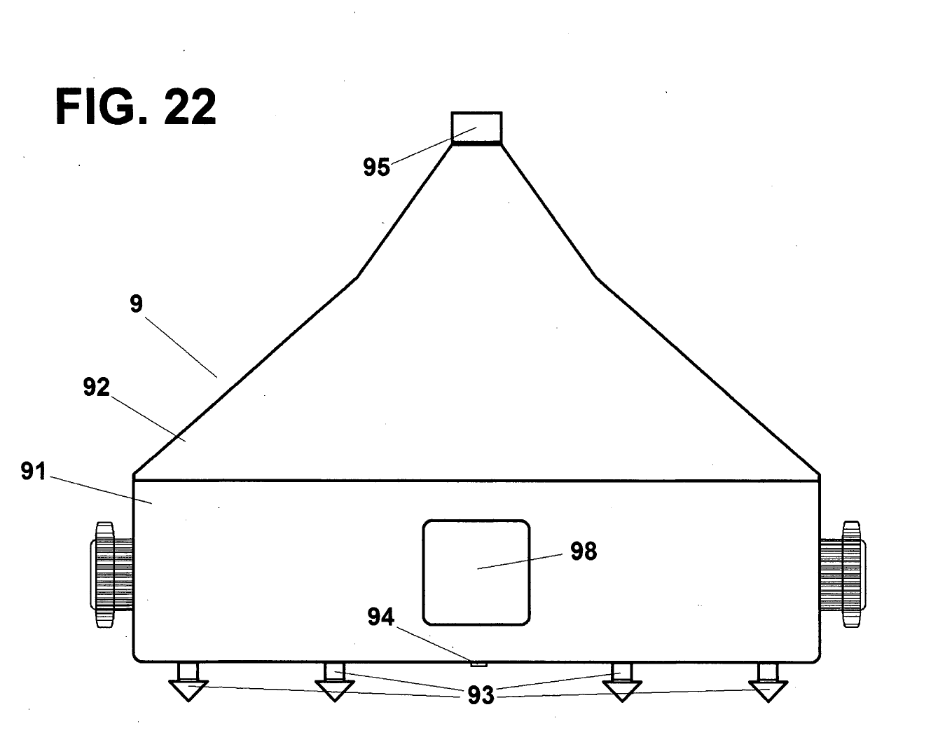

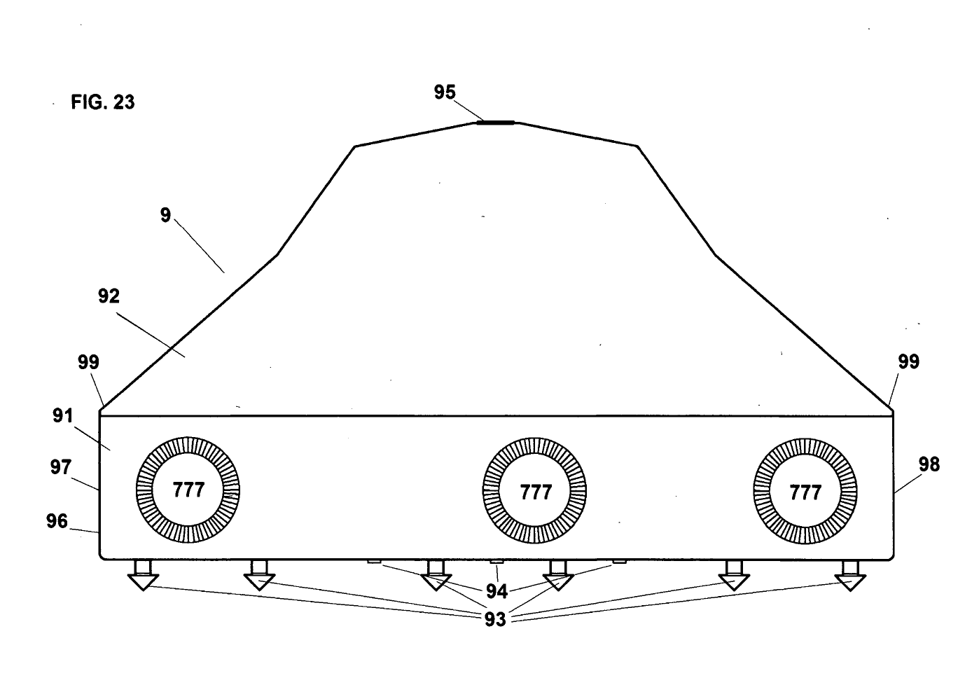

This invention relates to the fields of alternative energy production and acoustic energy harvesting (AEH). Specifically, this invention comprises a first acoustic driver (12) mounted in an enclosure (1) powered by electrical capacitors (10) driven by a microcontroller and frequency generator (11) with an external feedback loop for external control (101), and inputs from the electromagnetic-induction-circuits (42, 43, 44, 45, 46, 47, 48, 4941, 4942, 4943, 4944, 4951, 4952, 4953, 4954, 4955, 4956, 4957, 4958) acting as operational data sensors and recharging the internal-capacitors that power the first acoustic driver making this invention self-sustaining, connected to a plurality of extensible mechanically-coupled (33, 633) tuned-(20, 21, 22, 2201, 50, 51, 52, 5201, 5202, 5203, 5204 60, 61, 62, 6201, 6202, 6203, 6204, 6205, 6206, 6207, 6208) closed-column-resonator (2, 5, 6)-tuned (30, 31, 32, 3221, 3222, 3223, 3224, 3251, 3252, 3253, 3254, 3255, 3256, 3257, 3258)-Helmholtz-resonator (3)-piezo-poly-passive-radiator (40)-Electro-Magnetic-Induction-circuit (42, 43, 44, 45, 46, 47, 48, 4941, 4942, 4943, 4944, 4951, 4952, 4953, 4954, 4955, 4956, 4957, 4958) vibrational and acoustic piezoelectric resonator (6, 63, 64, 65, 7, 70, 701) systems that constitute an acoustic energy harvesting (AEH) device that mechanically amplifies induced (12) sound pressure levels via standing wave resonance such that the anti-node/s of the natural resonant frequency/ies in the tuned (20, 21, 22, 2201, 50, 51, 52, 5201, 5202, 5203, 5204, 60, 61, 62, 6201, 6202, 6203, 6204, 6205, 6206, 6207, 6208) closed-column-resonator/s (2, 5, 6) occurs in the plane/s consistent with the coupling ports (33, 633) of the attached tuned-Helmholtz resonator/s (3, 7, 70, 701) and acoustic-refrigeration-core/s (777, 7771)) acoustically driving the tuned-Helmholtz resonator/s (3, 7, 70, 701) of physical parameters such that standing wave resonance occurs within the tuned-Helmholtz resonator/s (3), one wall of which is a passive-radiator (4) comprising a sympathetically oscillating poled-piezo-polymer surround (42)-mounted non-poled-piezo-polymer tympanic membrane (43) the face/s of which is/are mounted with thin film ferromagnetic solenoids (44) connected by insulated conductor wire (45) to electrodes (46) that derive an electric field from the oscillating piezo-polymer surround (42) to self-induce magnetic fields from the thin film ferromagnetic solenoids (44) oscillating through stationary inductor coil/s (47) with electrodes (48) housed in the throat (49) acting as regional sensors providing real-time systems operations data (4941, 4942, 4943, 4944, 4951, 4952, 4953, 4954, 4955, 4956, 4957, 4958) and recharging the internal capacitors (10) that power the first acoustic driver, connecting the tuned-Helmholtz resonator (3)-piezo-poly-passive-radiator (40)-electromagnetic-induction-circuit (42, 43, 44, 45, 46, 47, 48, 4941, 4942, 4943, 4944, 4951, 4952, 4953, 4954, 4955, 4956, 4957, 4958) to the subsequent mechanically-coupled (33) tuned-(50, 51, 52, 5201, 5202, 5203, 5204) closed-column-resonator (5)-tuned-Helmholtz-resonator (3)-passive-radiator (40)-electromagnetic-induction-circuit (42, 43, 44, 45, 46, 47, 48, 4941, 4942, 4943, 4944, 4951, 4952, 4953, 4954, 4955, 4956, 4957, 4958) and subsequent mechanically-coupled (633) tuned-(60, 61, 62, 6201, 6202, 6203, 6204, 6205, 6206, 6207, 6208) closed-column-piezo-ceramic-resonator/s (6, 63, 64, 65) and tuned-piezo-ceramic-Helmholtz-resonator/s (7, 70, 701) and acoustic-refrigeration-core/s (777, 7771) generating electricity (42, 47, 63, 64, 65, 7, 70, 701), magnetic fields (44), increased kinetic energy, temperatures and pressures (2, 3, 4, 5, 6, 63, 64, 65, 7, 70, 701, 777, 7771) that is self-sustaining. This Invention is self-sustaining, extensible and scalable, the power output of which is constrained by the physical limits of piezo-polymers, piezo-ceramics, electrodes, conductors, high-amplitude acoustic wave coherence, shockwave formation and choking, latent heat tolerance as well as determined by the desired embodiments of the present Invention from micro-power applications utilizing ultrasonics (FIG. 9) to macro-power applications utilizing acoustics and infrasonics (FIGS. 12, 13, 14, 15, 19, 20, 21, 22, 23). The tuned-closed-column piezo-ceramic-resonators (63, 64, 65) and tuned-piezo-ceramic-Helmholtz-resonators (7, 70, 701) are comprised of piezo-ceramics, (63, 64, 65, 71, 72) with high-efficiency electrodes (74, 75) connected to master electrodes (795) configured to transmit power (797, 798) to an external device, bonded to and contained within thermally conductive, electrically insulated titanium shells (77, 78) the externalities of which are coated in titanium-nitride for high-power acoustic and infrasonic applications and of appropriate polymer materials for smaller, lower-power ultrasonic applications such as battery replacement technology for batteries like lead-acid, alkaline and Li-Ion, etc. . . . (FIG. 9). The present Invention is a self-sustaining, acoustically-driven, closed, pressurized system that intentionally increases kinetic energy and temperature via sound pressure mechanical amplification via multiple sequential standing wave resonances. This system generates electricity, magnetic fields, steam and cooling, and is self-sustaining.

The absence of additional active cooling mechanisms (777, 7771) and passive heat sinks for micro-power applications dictates the maximum internal sound pressure level and corresponding heat signature determined by each such embodiment. The pressures and temperatures in this last stage of acoustic and infrasonic embodiments are dangerously high and driveaxial-regenerating-stack (7772) acoustic-refrigeration-cores (777) attached to the previous tuned-closed-column-resonator such that the hot-heat-exchanger (7773) is in the center of the cavity, immersed in liquid-water, and the cold-heat-exchanger (7774) is at the second end of the cavity consisting of a thick endcap (7775) acting as a cold thermal mass for cold-heat-exchange with an external working-fluid-cooling system, protruding from the fluid-water-filled containment vessel (9) supplying active cooling (96) to prevent material fatigue and catastrophic systems failure and noise reduction (8, 91, 92, 93) and cancelling to prevent facilities damage and death or bodily harm to people and animals.

This invention transcends the notion of translating ambient, nuisance sound and vibration energy into usable electricity due to the numerous physical and engineering complications and inefficiencies present in such open-air broad-spectrum systems and instead this Invention is a self-sustaining, acoustically-driven, closed, pressurized acoustic energy harvesting device that generates specific frequencies (101, 1, 10, 11, 12) in tuned (20, 21, 22, 2201, 50, 51, 52, 5201, 5202, 5203, 5204 60, 61, 62, 6201, 6202, 6203, 6204, 6205, 6206, 6207, 6208) closed-column-shaped cavities (2, 5, 6) stimulating standing wave resonance such that the anti-nodes of the standing waves are in the plane/s consistent with the coupling ports (33, 633) of the attached tuned-Helmholtz resonator/s (3, 7, 70, 701) and acoustic-refrigeration-core/s (777, 7771) acoustically driving the tuned-Helmholtz resonator/s (3, 7, 70, 701) of physical parameters such that standing wave resonance occurs within the tuned-Helmholtz resonator/s (3), one wall of which is a passive-radiator (4) comprises a sympathetically oscillating poled-piezo-polymer surround (42)-mounted non-poled-piezo-polymer tympanic membrane (43) the face/s of which is/are mounted with thin film ferromagnetic solenoids (44) connected by insulated conducting wire (45) to electrodes (46) that derive an electric field from the oscillating piezo-polymer surround (42) to self-induce magnetic fields from the thin film ferromagnetic solenoids (44) oscillating through stationary inductor coil/s (47) with electrodes (48) housed in the throat (49) acting as regional sensors providing real-time systems operations data (4941, 4942, 4943, 4944, 4951, 4952, 4953, 4954, 4955, 4956, 4957, 4958) and recharging the internal capacitors (10) making this invention self-sustaining, connecting the Helmholtz resonator (3)-passive-radiator (40)-electromagnetic-induction-circuit (42, 43, 44, 45, 46, 47, 48, 4941, 4942, 4943, 4944, 4951, 4952, 4953, 4954, 4955, 4956, 4957, 4958) to the subsequent mechanically-coupled (33) tuned (50, 51, 52, 5201, 5202, 5203, 5204) closed-column-resonator (5)-Helmholtz-resonator (3)-passive-radiator (40)-electromagnetic-induction-circuit (42, 43, 44, 45, 46, 47, 48, 4941, 4942, 4943, 4944, 4951, 4952, 4953, 4954, 4955, 4956, 4957, 4958) and subsequent mechanically-coupled (633) tuned-(60, 61, 62, 6201, 6202, 6203, 6204, 6205, 6206, 6207, 6208) closed-column piezo-ceramic-resonator/s (6, 63, 64, 65, 635, 645, 655) and tuned-piezo-ceramic-Helmholtz-resonator/s (7, 70, 701, 74, 75, 731, 732, 795, 797, 798) and acoustic-refrigeration-core/s (777, 7771) generating electricity (42, 47, 63, 64, 65, 7, 70, 701) transmitted to external devices (797, 798, 799), magnetic fields (44), increased kinetic energy, temperatures and pressures (2, 3, 4, 5, 6, 63, 64, 65, 7, 70, 701, 777, 7771) that are self-sustaining.

In a tuned-closed-column resonating cavity both ends are closed. The first acoustic driver is at the first end and the second end comprises a plunger with both manual and automatic controls for changing the volume and therefore the resonant frequency of the closed-column resonating cavity thereby rendering the closed-column resonating cavity tunable. The sound pressure level (SPL) of the input acoustic signal is increased by 32 dB by standing wave resonance which is 512 times higher than the input pressure. The perpendicularly mounted tuned-Helmholtz resonator/s is/are located at the anti-node/s of the incident standing wave in the previous tuned-closed-column resonating cavity and are mechanically-coupled with the preceding closed-column resonating cavity by their shared body of gas. The tuned-Helmholtz-resonators have one wall comprising a plunger with both manual and automatic controls for changing the volume of the Helmholtz-resonator rendering the Helmholtz-resonator tunable. The SPL inside the Helmholtz resonators increases by an additional 32 dB because of the input frequency stimulating the tuned-Helmholtz resonating cavities natural resonant frequency. Accordingly, the original acoustic input signal of 32 dB, barely a whisper, becomes 64 dB, casual conversation level, due to standing wave resonance in the first closed-column resonating cavity and increases an additional 32 dB to 96 dB, using a belt-sander, in the first Helmholtz resonator, an increase of 1024 times the input pressure wave via mechanical amplification due to multiple sequential cavity resonances. The pressures and temperatures in this last stage of acoustic and infrasonic embodiments are dangerously high and drive axial-regenerating-stack (7772) acoustic-refrigeration-cores (777, 7771) attached to the previous tuned-closed-column-resonator such that the hot-heat-exchanger (7773) is in the center of the cavity, immersed in liquid-water, and the cold-heat-exchangers (7774) are at the first end and second end of the cavity, the second end consisting of a thick endcap (7775) acting as a cold thermal mass for cold-heat-exchange with an external working-fluid-cooling system, some of the second ends protruding from the fluid-water-filled containment vessel (9) supplying active cooling (96), the cold-heat exchangers at the first end regulate internal temperature to prevent material fatigue and catastrophic systems failure, and noise reduction (8, 91, 92, 93) and cancelling to prevent facilities damage and death or bodily harm to people and animals. This self-sustaining Invention transcends the obvious tuned-closed-column-resonator-tuned-Helmholtz-resonator construction by making one wall of the tuned-Helmholtz-resonator a passive-radiator by fabricating one wall out of a sympathetically oscillating poled-piezo-polymer surround-mounted tympanic membrane the face/s of which is/are non-poled-piezo-polymer mounted with thin film ferromagnetic solenoids that derive electric fields from the oscillating piezo-polymer surround to self-induce magnetic fields that oscillate along the passive-radiator's length of travel, in response to the incident SPL commensurate with the frequency and amplitude within the tuned-Helmholtz-resonator, through stationary inductor coil/s housed in the throat connecting the tuned-Helmholtz resonator-passive-radiator-electromagnetic-induction-circuit, acting as regional sensors providing real-time systems operations data and recharging the internal capacitors that power the first acoustic driver making this invention self-sustaining, to the two subsequent mechanically-coupled tuned-closed-column-resonator/s-tuned-Helmholtz-resonator/s-passive-radiator/s-electromagnetic-induction-circuit/s stages until driving the tuned-piezo-ceramic-closed-column/s, tuned-piezo-ceramic-Helmholtz-resonator/s and axial-regenerating-stack acoustic-refrigeration-cores attached to the previous tuned-closed-column-resonator such that the hot-heat-exchanger (7773) is in the center of the cavity, immersed in liquid-water, and the cold-heat-exchangers (7774) are at the first end and second end of the cavity, the second end consisting of a thick endcap (7775) acting as a cold thermal mass for cold-heat-exchange with an external working-fluid-cooling system, some of the second ends protruding from the fluid-water-filled containment vessel (9) supplying active cooling (96), the cold-heat exchangers at the first end regulate internal temperature to prevent material fatigue and catastrophic systems failure, and noise reduction (8, 91, 92, 93). Each of these tuned-closed-column-resonator-tuned-Helmholtz-resonator-passive-radiator-electromagnetic-induction-circuit assemblies accepts the previously mechanically amplified acoustic standing wave and mechanically amplifies it an additional 64 dB, minus losses due to spring constant, k, of the poled-piezo-poly surround, acoustic impedance of the gas and cavities and friction, before acoustically driving the subsequent resonator stage via the passive radiator wall of the tuned-Helmholtz-resonator. The poled-piezo-poly surround (42)-mounted non-poled-piezo-poly tympanic membrane (43) passive-radiator-electromagnetic-induction-circuit generates electric fields that pass through electrodes (46) into an insulated conducting wire (45) into thin-film ferromagnetic solenoids (44) generating magnetic fields that induce exponentially higher electric fields in the throat (49)-mounted induction coils (47) as the tympanic membrane (43) that the ferromagnetic solenoids (44) are attached to oscillates sympathetically through the length of its lateral travel in response to the incident SPL commensurate with the frequency and amplitude within the tuned-Helmholtz-resonator (3) acting as regional sensors providing real-time systems operations data and recharging the internal capacitors that power the first acoustic driver making this invention self-sustaining. The present invention repeats this mechanical amplification via acoustically driving mechanically-coupled tuned-closed-column-resonator/s-tuned-Helmholtz-resonator/s-passive-radiator/s-electromagnetic-induction-circuit assembly/ies stages according to the desired power specifications of each embodiment up to the physical limits of the materials. This present invention can mechanically amplify a 32 dB input signal into 190+dB with three stages of mechanically-coupled tuned-closed-column resonator/s-tuned-Helmholtz-resonator/s-passive-radiator/s-electromagnetic-induction-circuit assemblies, effectively turning a whisper into a shockwave. These 190+dB shockwave intense acoustic waves generate SPLs that translate to 10+ megawatts (MW) per square meter of acoustic power. The piezo-ceramic lined tuned-closed-column and tuned-Helmholtz resonators at the termination of the 3^{rd} stages translate up to 700+ watts of electricity per square centimeter of piezo-ceramic exposed to the pressures and temperatures at 190 dB and up to 7 kW per square centimeter at 200 dB. Methods for stimulating the Young's modulus of the piezo-ceramics include combining the sonic frequency/ies with the infrared signature from the gas type and stimulating the plasma in the final stage tuned-piezo-ceramic-closed-column-resonator/s and tuned-piezo-ceramic-Helmholtz resonator/s with an electric field to stimulate spontaneous photon emission of a known spectrum that in concert with the other methods can stimulate electrical output up to the physical limits of the bulk modulus of the piezo-ceramics. The pressures and temperatures in this last stage of acoustic and infrasonic embodiments are dangerously high and drive axial-regenerating-stack acoustic-refrigeration-cores such that the hot-heat-exchanger is in the center of the cavity and the cold-heat-exchangers are at the first end and second end of the cavity, some of the second ends protruding from the liquid-water-filled containment vessel supplying active cooling the cold-heat exchangers at the first end regulate internal temperature to prevent material fatigue and catastrophic systems failure, and noise reduction and cancelling to prevent facilities damage and death or bodily harm to people and animals. The ultrasonic embodiments of the present Invention also require a combination of active and passive cooling systems at these higher power output levels, but do not require sound cancellation as the target frequencies are above human and domestic animal hearing capacities, however, prolonged near-field and contact exposure can cause serious tissue damage over time.

The ultrasonic embodiments of the present Invention are envisaged as battery replacement technology for most existing battery types from AAA 1.5V in remote controls, to Li-Ion batteries in handheld and wearable electronics and portable computing devices like laptops and tablets; and can be scaled up to replace electric vehicle, marine, and aeronautical battery systems and facilities-based back-up power supplies. The acoustic and infrasonic embodiments of the present Invention are envisaged as an alternative to fossil-fuel, hydro, geo-thermal, solar, wind and nuclear based electric power production systems for industrial and commercial grid delivery as well as stand-alone off-grid large facilities power supply in addition to vehicle, vessel and craft power. The use of the VAPER-ARC™ reactors for energy production, electric jet flight and marine shipping would eliminate the three largest causes of GHGs and soot contributing to negative planetary evolution a.k.a. climate change. These particular embodiments of the present Invention would also lower the overall operating costs of any business utilizing them from fuel-savings, carbon-credits, regulatory costs and infrastructure costs.

Real world applications for the present invention include but are not limited to configurations in high-energy physics research facilities, cryogenics research facilities, public spaces such as, but not limited to, power generating stations, factories, stadiums, train stations & rail yards, subway stations, bus stations, airports, shipyards, ports, tunnels, bridges, highways, roadways, gymnasiums, concert halls, office buildings, hospitals, healthcare organizations, detention facilities, correctional facilities, military facilities, commercial spaces, retail spaces, and industrial & manufacturing spaces. Further applications could include, but not be limited to, wearable and handheld electronics and electrical equipment, vehicles and transportation of any configuration including but not limited to space-stations, spacecraft, sub-orbital craft, satellites, airplanes, helicopters, fixed-wing and rotary-wing aircraft, ultralight aircraft, UAVs, MUAVs, UUAVs, parachutes, flying suits, flying armored suits, prosthetics, wearable computing platforms, armored terrestrial suits, HAZMAT suits, diving suits/systems, spacesuits, EVA spacesuits, locomotives, trains, automobiles, trucks, construction vehicles, earthmovers, mining equipment, half-tracks, tracked vehicles, watercraft, hovercraft, submarines, drill-rigs, floating drill-rigs, motorcycles, unicycles, motor-scooters, electric bicycles, ATVs, golf carts, and snowmobiles. The preceding examples constitute some, not all, possible configurations and applications of the present invention. Variations should not materially alter the nature of the present invention. Thus the scope of the invention should be fixed by the following claims rather than any specific example cited.

I claim:

1. A self-sustaining system of vibrational and acoustic piezoelectric resonators generates electricity by a first externally-controlled electrically-powered acoustic driver connected to a plurality of extensible mechanically-coupled tuned-closed-column-resonator-tuned-Helmholtz-resonator-piezo-poly-passive-radiator-electromagnetic-induction-circuit vibrational and acoustic piezoelectric resonator systems that constitute an acoustic energy harvesting device that drives acoustic-refrigeration-cores some protruding from the liquid-water-filled containment vessel
a. the acoustic-refrigeration-cores are axial-regenerating-stack acoustic-refrigeration-cores
b. such that the hot-heat-exchanger is in the center of the acoustic-refrigeration-core cavity and the cold-heat-exchangers ares at the first end and second end of the cavity
c. the cold-heat exchanger at the first end regulates internal temperatures in the preceding tuned-closed-column-resonator
d. the second end of some cavities protruding from the liquid-water-filled containment vessel
e. the second end of the prodtruding cavities consisting of a thick endcap acting as a cold thermal mass for cold-heat-exchange with an external working-fluid-cooling system,
f. the acoustic-refrigeration-core cold-heat-exchanger/s protruding from the containment vessel connected to an external working-fluid-cooling system that cools the pressurized steam evacuated from the containment vessel in a closed loop
g. the non-protruding acoustic refrigeration cores acting as temperature regulators for the preceeding closed-column-resonating cavities

2. A fluid-water-filled containment vessel comprising
a. An upper and lower hemisphere
b. Secured together by fasteners in drilled and tapped holes around the perimeter of the meeting of the hemispheres
c. With a sealing gasket between the hemispheres to insure pressure seal integrity
d. supplying active cooling via cold water injection through the cold-water injection port in the lower hemisphere
e. pressurized steam evacuation via the steam port in the upper hemisphere
f. A port for feedback and control systems wiring to external control systems
g. A port for electricity transmission via large insulated conductors to external systems
h. noise reduction via the internal geometry of the upper and lower hemispheres
i. noise reduction and translational vibration reduction via the apparatus support structure with conical contact pads inside the containment vessel
j. noise reduction and translational vibration reduction via the conical contact pads underneath the containment vessel
k. asymmetrical bottom with compound curves creating three distinct basins with different volumes and acoustic reflection properties eliminating whole cavity sympathetic resonance

3. the apparatus support structure with conical contact pads as in claim 2 further comprising
a. asymmetric truss geometry preventing constructive interference and sympathetic harmonic vibration in the support structure
b. a single point of contact between each tuned-closed-column-resonating cavity and the apparatus support structure minimizing vibrational energy translation
c. conical contact pad placement within the containment vessel such that the external conical contact pads are not directly underneath any of the internal apparatus support structure conical contact pads reducing vibrational energy translation.
